(19) United States
(12) Patent Application Publication
(10) Pub. No.: US 2003/0002106 A1
(43) Pub. Date: Jan. 2, 2003

(54) Cross-connect switch and network

(75) Inventors: Seigo Takahashi, Tokyo (JP); Naoya Henmi, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/175,043

(22) Filed: Jun. 20, 2002

(30) Foreign Application Priority Data
Jun. 27, 2001 (JP) 193870/2001

(51) Int. Cl. H04J 14/00; H04J 14/02

(52) U.S. Cl. 359/128; 359/117

(57) ABSTRACT

In a cross-connect switch for transmitting an input signal to any one of a plurality of outgoing lines, the cross-connect switch includes a switch of which output port is connected to any one of the plurality of outgoing lines, and each of the plurality of outgoing lines is connected to a predetermined one of a plurality of paths. If the input signal to the cross-connect switch is a wavelength division multiplexing optical signal, then the cross-connect switch further includes a demultiplexer for demultiplexing the input signal into wavelength components, and a multiplexer for multiplexing signals on the outgoing lines which are connected to any one of the plurality of paths. The switch may include a two-stage-linked connection circuit network. Moreover, the cross-connect switch includes a first wavelength converter inserted between the demultiplexer and an input port of the switch, and a second wavelength converter inserted between an output port of the switch and the multiplexer. A conversion wavelength of the second wavelength converter may be variable.

### BACKGROUND OF THE INVENTION

1. Field of the Invention

The present invention relates to cross-connect switches. More specifically, the present invention relates to a cross-connect switch for a transmission line using a wavelength division multiplexing technology, and to a network using the cross-connect switch.

2. Description of Related Art

An increase in capacities of cross-connect nodes for configuration of a trunk network is now demanded. Typical reasons for such a demand includes: (1) explosive growth of telecommunication capacities in recent years; and (2) an increase in accommodable traffics of a cross-connect node, which is associated with expansion in transmission-line capacities attributed to wavelength division multiplexing technologies. Particularly, along with an increase in data traffics in recent years, cross-connect granularities of conventional bandwidths such as STS-1 (equivalent to 52-Mbps private lines) or OC-3c (15-Mbps private lines) are not demanded, but demanded are cross-connect granularities as wide as the original bandwidths of the transmission lines such as OC-48c or OC-192c.

Resultantly, whereas cross connection of a capacity of 40 Gbps, for example, has been considered as a sufficient cross-connect capacity in a conventional network, such a scale is now effective for holding only four lines if the cross-connect granularity thereof is arranged for OC-192c (10-Gbps private lines). As a consequence, a cross-connect switch fabric demanded therein has been composed of crosspoint switches, and a capacity of the switch fabric has grown to an enormous scale.

Meanwhile, since it is difficult to configure a large-scale crosspoint switch with a single switching matrix, such a crosspoint switch is configured in reality by a combination of a plurality of unit switches. Expansion of cross-connect capacities has brought about increases in volumes and heat generation amounts of overall switches and an increase in the number of interconnection wiring inside the switches. Eventually, implementation costs are increased in connection therewith.

For example, when a 64×64-port non-blocking cross-connect switch is composed of a Clos switch, 24 pieces of 16×16-port unit switches are required and the number of interconnections enclosed within the switches counts 256 lines.

Similarly, regarding a 512×512-port non-blocking cross-connect switch composed of 32×32-port unit switches, the number of the unit switches counts 96 pieces and the number of interconnections counts up to 2,048 lines.

In such a large-scale configuration, if electrically integrated circuits (ICs) are used, it is impossible to mount nearly 100 pieces of unit switching ICs on a single printed circuit board because a board area is limited. As a result, technologies for effectuating distribution of the ICs to a plurality of circuit boards as well as effectuating interconnection among the circuit boards are required. In the meantime, if optical switches are used, then transmission losses of the optical switches are not ignorable. For example, assuming that a transmission loss of one 32×32-port unit optical switch is 8 dB, then transmission losses are accumulated up to 24 dB after passing three stages of switches. As a result, an optical signal transmitted through the switches cannot secure a sufficient S/N ratio. Accordingly, it is necessary to insert optical amplifiers, regenerators or the like between the switches. Eventually, increases in costs, power consumption and volumes of the overall switches are incurred.

### SUMMARY OF THE INVENTION

An object of the present invention is to provide a cross-connect switch capable of reducing the number of unit switches in comparison with the prior art.

A cross-connect switch according to the present invention is a cross-connect switch for transmitting an input signal to any one out of a plurality of outgoing lines, in which each output port thereof includes a switch connected to any one out of the plurality of outgoing lines, and each of the plurality of outgoing lines is connected to a predetermined one of a plurality of paths.

A network according to the present invention is a network provided with a plurality of interconnected nodes, in which each node includes the cross-connect switch.

### BRIEF DESCRIPTION OF THE DRAWINGS

The above and other objects, features and advantages of the present invention will become more apparent from the following detailed description when taken in conjunction with the accompanying drawings wherein:

FIG. 1 is a block diagram of one example of a conventional three-stage Clos switch;

FIG. 2 is a view showing concrete connection between the conventional three-stage Clos switch and transmission lines;

FIG. 3 is a block diagram of a first embodiment of the present invention;

FIG. 4 is a block diagram of a third embodiment of the present invention;

FIG. 5 is a block diagram of a second embodiment of the present invention; and

FIG. 6 is a block diagram of a fourth embodiment of the present invention.

### DETAILED DESCRIPTION OF THE PREFERRED EMBODIMENTS

First of all, before describing a cross-connect switch of the present invention, description will be made regarding a conventional cross-connect switch in order to facilitate understanding of the invention.

A large-scale cross-connect system requires a non-blocking and large-capacity switch fabric. Conventionally, a configuration of a large-scale switch has been achieved by combination of unit switch ICs, each unit switch IC having N (N is a positive integer) terminals. To be more precise, a Clos switching network (refer to C. Clos, “A study of non-blocking switching networks”, Bell Syst. Tech. J., 32, 2, pp. 406-424, 1953), tetragonal lattice expansion and parallelization according to bit-slicing are cited.

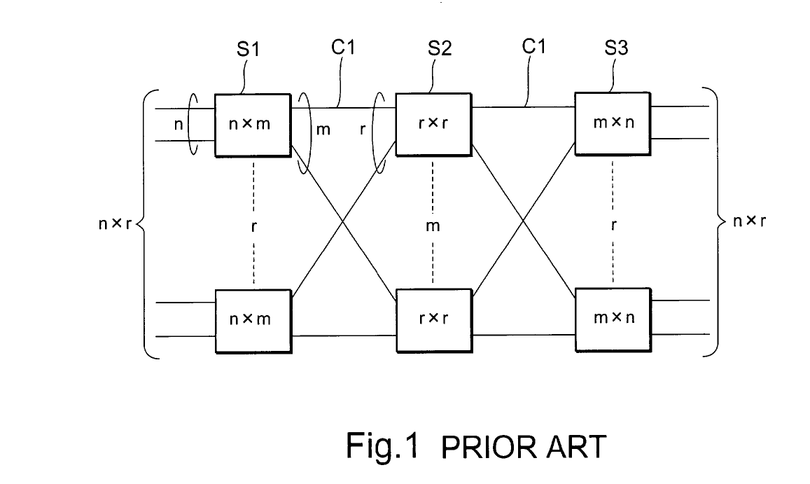

Among them, the Clos network is known to be most efficient in terms of a switching scale and the number of elements. FIG. 1 is a block diagram of one example of a conventional three-stage Clos switch. As shown in the drawing, the three-stage Clos switch effectuates configuration of a large-scale switch fabric by combination of a plurality of unit switches S1, S2 and S3. Moreover, a strict-sense non-blocking switch is formed under a constitution defined as m≧2n−1 (m and n are positive integers, respectively), and a rearrangeably non-blocking switch is formed under a constitution defined as m≧n (the Slepian-Duguid theorem).

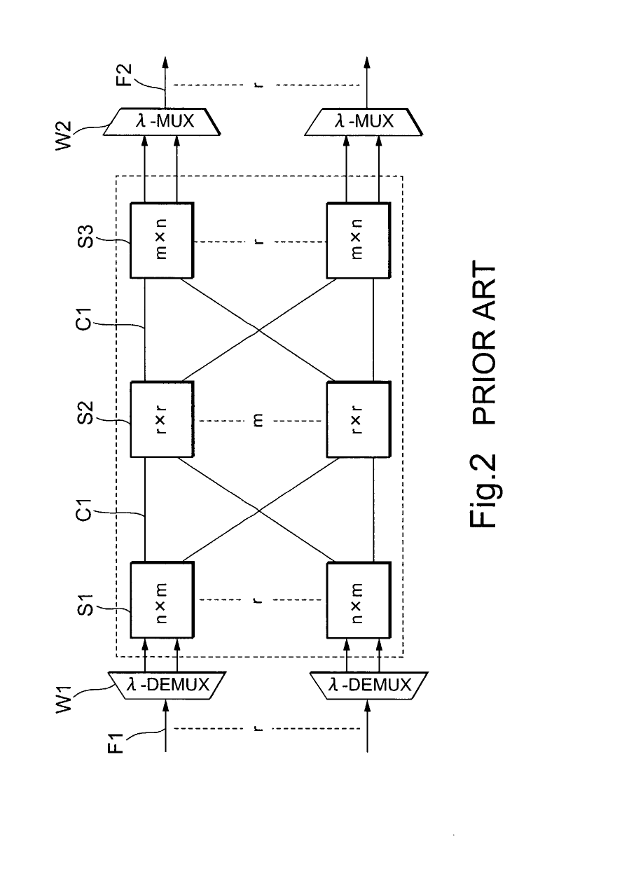

FIG. 2 is a view showing concrete connection between the conventional three-stage Clos switch and transmission lines. The drawing illustrates a relation between the configuration of the three-stage Clos switch and transmission lines using a wavelength division multiplexing (WDM) technology. Here, addresses of input to first-stage unit switches S1 and addresses of output from third-stage unit switches S3 of the Clos switch are subjected to wavelength division multiplexing (WDM) severally with wavelength demultiplexers (λ-DEMUX) W1 and wavelength multiplexers (λ-MUX) W2, and are connected severally to fibers F1 and F2 of identical paths.

(First Embodiment)

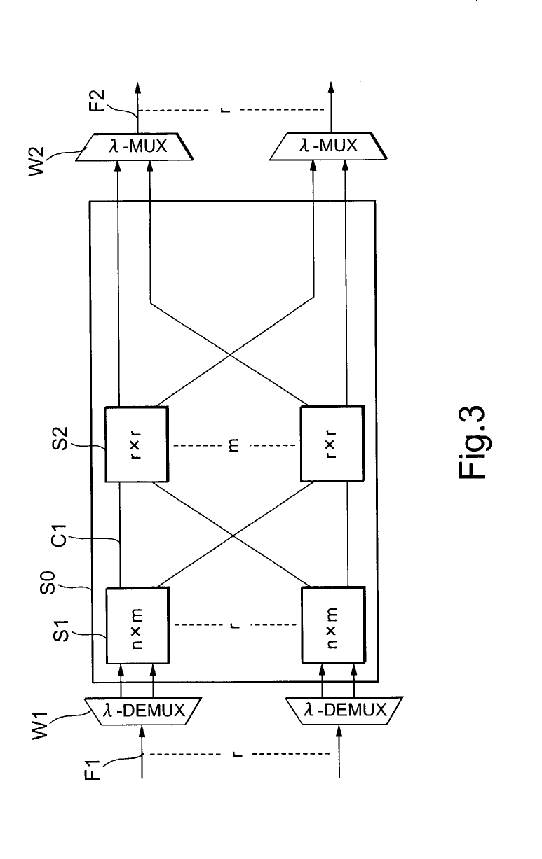

Now, the preferred embodiments of the present invention will be described with reference to the accompanying drawings. To begin with, description will be made regarding a first embodiment. FIG. 3 is a block diagram of the first embodiment of the present invention. As shown in the above-mentioned FIG. 2, all input signals at the third-stage unit switches S3 are multiplexed resultantly on the same fiber F2 regardless of states of connection of the third-stage unit switches S3.

While utilizing such a relation, it is conceivable to provide the WDM multiplexer W2 with a function as a unit switch for selecting a port out of paths, by means of permitting only a path (in particular, a fiber) to be designated as an output of a switch but a particular switch output port or wavelength not to be designated. In other words, as shown in FIG. 3, the third-stage unit switches S3 of the three-stage Clos switch can be curtailed. In this event, even if the wavelength is not designated, a subsequent node of destination is uniquely determined only by connection of fibers. Accordingly, a path non-blocking switch S0 of the present invention, which is formed in combination of WDM transmission lines, does not restrict connecting functions on a network.

According to the above-described path non-blocking configuration, the number of unit switches required for a large-scale switch and the number of interconnections are reduced. To be more precise, in the above-mentioned 512×512-port configuration, the number of unit switches is reduced to ¾ and the number of interconnections is reduced to ½. Note that the above-described method of configuration is applicable to both an optical switch and an electric IC switch.

A concrete example of the first embodiment will now be described. As shown in FIG. 3, the cross-connect switch S0 according to the present invention includes r pieces of first-stage unit switches (n×m) S1, m pieces of second-stage unit switches (r×r) S2 and interconnections Cl provided severally between the first-stage unit switches S1 and the second-stage unit switches S2.

Further, wavelength demultiplexers (λ-DEMUX) W1 are connected to input sides of the respective first-stage unit switches S1, and wavelength multiplexers (λ-MUX) W2 are connected to output sides of the respective second-stage unit switches S2. Moreover, one multiplexed signal is inputted to an input path (a fiber F1) of each wavelength demultiplexer W1, and n demultiplexed signals are outputted to output paths of the wavelength demultiplexer W1. Similarly, m signals are inputted to input paths of each wavelength multiplexer W2 and one multiplexed signal is outputted to an output path (a fiber F2) of the wavelength multiplexer W2.

In other words, the path non-blocking switch S0 includes the r pieces of the first-stage unit switches S1 and m pieces of the second-stage unit switches S2, and the interconnections C1 achieve meshed connection therebetween. Signal light, which is inputted from the fiber F1 of the input path, is demultiplexed into n waves by the wavelength demultiplexer W1, and the waves are severally inputted to n input ports of the first-stage unit switches S1. Meanwhile, output signals from m pieces of the second-stage unit switches S2 are integrally connected to each wavelength multiplexer W2 on the output side. Then, the multiplexer W2 multiplexes m waves into one wave and outputs the wave to the fiber F2 of the output path.

In the above-described configuration, all the output signals from the second-stage unit switches S2 are resultantly multiplexed onto the identical fiber F2 regardless of existence of the third-stage unit switches S3 of the Clos switch. Therefore, the configuration is non-blocking with respect to the paths.

Moreover, the switch is configured symmetrically on the right side and the left side (on the input side and the output side). Accordingly, combinations between input terminals and the wavelength demultiplexers are thoroughly equivalent as similar to combinations between output terminals of the switch and the wavelength multiplexers.

(Second Embodiment)

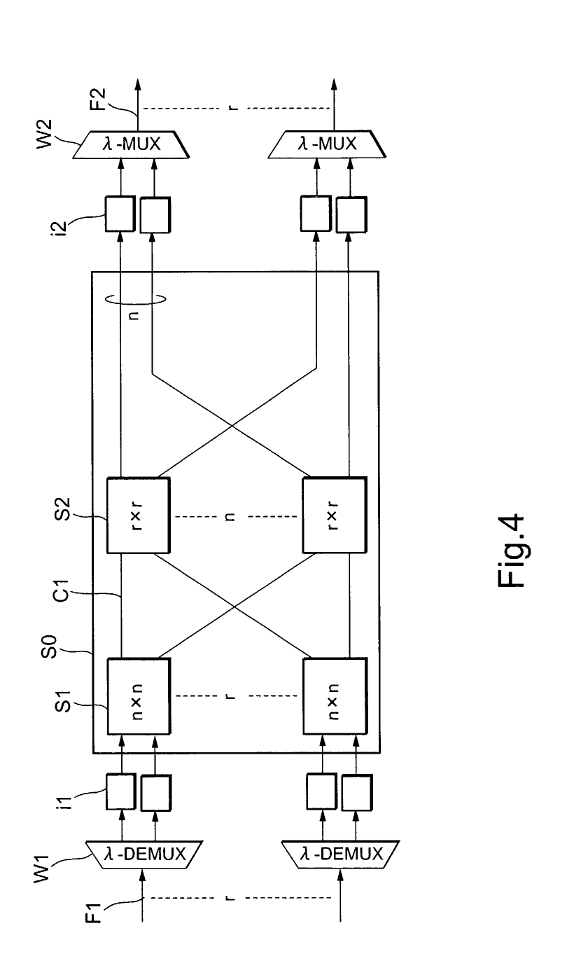

Next, a second embodiment will be described. Considering a concrete switch configuration, wavelength converters i1 and i2 are inserted in one or both sides of spaces between input/output portions of a path non-blocking switch and wavelength multiplexers/demultiplexers in the case of an optical switch (photoelectric converters are alternatively inserted in the case of an electric IC switch) (see the wavelength converters i1 and i2 in FIG. 4, for example).

Here, when an output wavelength of the wavelength converter (or the photoelectric converter) i2 on the output side of the path non-blocking switch is fixed, a bandwidth required in a transmission line is doubled as compared with a conventional configuration. In other words, in FIG. 3 for example, the number of signals to be inputted to an uppermost multiplexer W2 is equal to 2n. Whereas that the number of signals to be inputted to the uppermost multiplexer W2 is equal to m as it is obvious from the drawing, the number of signals to be inputted to the multiplexer W2 becomes equal to 2n because a condition m=2n is present. Next, description will be made regarding a concrete example thereof.

In FIG. 3, a signal F1 to be inputted to the wavelength demultiplexer W1 is assumed to be composed of W signals which are subjected to wavelength division multiplexing. Since the number of the signals F1 is equal to r lines and the number of the demultiplexers W1 is also r pieces, the number of signals outputted from the aggregate wavelength demultiplexers W1 is equal to W×r lines. Therefore, n=W is applicable. Now, the number of signals to be inputted to the uppermost wavelength multiplexer W2 is equal to m, while m=2n and n=W. Therefore, m=2W is applicable.

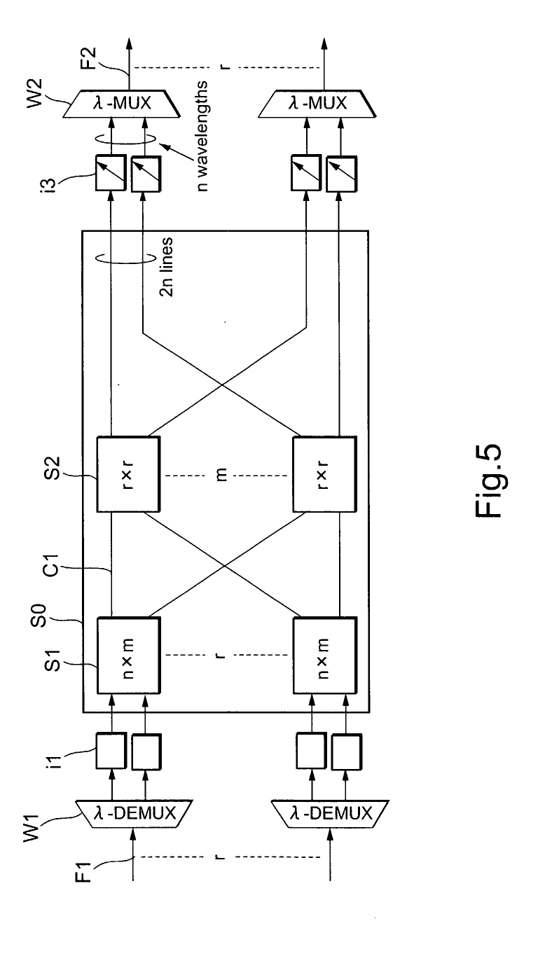

As described above, although the number of signals to be inputted to each of the wavelength multiplexers W2 is equal to 2n, a bandwidth actually used is equivalent to n lines as similar to the original three-stage Clos switch. Accordingly, a half of the total bandwidth will not be used. In order to solve this problem, as shown in a block diagram of the second embodiment in FIG. 5, an output wavelength of a wavelength converter i3 on an output side of a path non-blocking switch is set to a variable wavelength, thus enabling control in order not to cause collisions of wavelengths at the wavelength demultiplexer within an arbitrary or a limited wavelength range. As a result, it is possible to satisfy the requirement of the bandwidth for a transmission path with the same amount as a transmission capacity.

As for the wavelength converter, there is a constitution of cascade connection of a photo-electro converter and an electro-photo converter (referred to as a transponder), in which an output light wavelength of the electro-photo converter is set to a post-conversion wavelength. Alternatively, there is also a constitution of utilizing full optical wavelength division multiplexing which incorporates nonlinear optical effects such as four-wave mixing.

Next, a concrete example of the second embodiment will be described. This concrete example is another example of path non-blocking switches. The above-mentioned FIG. 5 is used for description of the concrete example. As shown in FIG. 5, a cross-connect switch S0 according to the present invention includes r pieces of first-stage unit switches (n×m) S1, m pieces of second-stage unit switches (r×r) S2 and interconnections C1 provided severally between the first-stage unit switches S1 and the second-stage unit switches S2.

Further, wavelength demultiplexers (λ-DEMUX) W1 are connected to input sides of the respective first-stage unit switches S1 via interfaces i1, and wavelength multiplexers (λ-MUX) W2 are connected to output sides of the respective second-stage unit switches S2 via interfaces i3. Moreover, one multiplexed signal is inputted to an input path (a fiber F1) of each wavelength demultiplexer W1, and n demultiplexed signals are outputted to output paths of the wavelength demultiplexer W1. Similarly, m signals are inputted to input paths of each wavelength multiplexer W2 and one multiplexed signal is outputted to an output path (a fiber F2) of the wavelength multiplexer W2.

In other words, upon configuring the cross-connect switch actually, the interfaces i1 and i3 are inserted severally between the wavelength demultiplexers W1 and the large-scale switch S0, and between the wavelength multiplexers W2 and the large-scale switch S0. Wavelength converters are used as the interfaces when the large-scale switch S0 is an optical switch. On the contrary, photoelectric converters are used as the interfaces when the large-scale switch S0 is an electric IC switch.

As previously described, a bandwidth equivalent to 2n wavelengths, which is twice as wide as an actual bandwidth, would be required for a transmission bandwidth in the case when fixed-rate wavelength converters (or photoelectric converters) are used for the interfaces on the output side. Nevertheless, it is possible to satisfy such a requirement of the bandwidth just with n wavelengths at the minimum by use of the variable-wavelength wavelength converters (or the photoelectric converters) i3 as the interfaces on the output side.

(Third Embodiment)

Next, a third embodiment will be described. FIG. 4 is a block diagram of the third embodiment. As shown in the drawing, the third embodiment utilizes the nature of a Clos switch configuration, in which the Clos switch becomes rearrangeably non-blocking when configured as m=n (refer to the switches S1 (n×n) in FIG. 4). In this case, even if wavelength converters (or photoelectric converters) therein are set to fixed wavelengths, a transmission bandwidth previously required twice as wide as an actual bandwidth can be satisfactorily reduced to a bandwidth as the same width as the actual bandwidth at the minimum.

To be more precise, as compared with the above-described 512×512-port strict-sense non-blocking configuration, the number of unit switches is reduced by ⅓ down to 32 pieces and the number of interconnections is reduced by ¼ down to 512 lines (equivalent to a configuration of disposing 16 pieces of 32×32-port switches on the first stage and the second stage, respectively).

Incidentally, in the case of using a path non-blocking switch configuration which allows rearrangement, connection rearrangement of the switch is specifically associated with modification of wavelengths as a result of modification of connecting second-stage unit switches therein. As a consequence, modification of input ports at subsequent cross-connect nodes may be incurred, and such modification may further affect switch connection of other nodes. Nevertheless, such a problem is considered as avoidable beforehand by advance designing, regardless of whether network management is centralized or decentralized.

However, if an entire network is constructed with such rearrangeable path non-blocking switches, there is a risk that designs are extremely complicated. In this concern, it is possible to strike a good balance between partial cost reductions and avoidance of adverse influences on the entire network, by means of selectively adopting the rearrangeably non-blocking switches to nodes with less impact.

Incidentally, a power-off state occurring in the event of rearrangement may cause an excessively protective action. Therefore, a control system such as masking power-off detection should be combined in advance.

Note that a solution for the problem associated with the modification of connecting the second-stage unit switches will be further described in the following fourth embodiment.

Next, a concrete example of the third embodiment will be described. This concrete example is an example of rearrangeably non-blocking switches. The above-mentioned FIG. 4 is used for description of the concrete example. As shown in the drawing, the only difference from the second embodiment is that the output side interfaces (the variable-wavelength wavelength converters) i3 are changed with output side interfaces (fixed-wavelength wavelength converters) i2.

This Clos switch shows an embodiment of the rearrangeable path non-blocking switch utilizing the nature of being rearrangeably non-blocking in a configuration where m≧n. In FIG. 4, a condition m=n is applied for example. In this way, the number of signals to be inputted to each wavelength multiplexer W2 is set to n. Accordingly, even if the fixed-rate wavelength converters (or photoelectric converters) are used as the output side interfaces i2, it is possible to satisfy a transmission bandwidth with a width equal to an actual bandwidth.

(Fourth Embodiment)

Next, a fourth embodiment will be described. In a network configured with cross-connect nodes using the rearrangeable path non-blocking switches of the present invention, if reconnection of a switch occurs at one node, then such modification bears a risk of affecting the entire network. As a result, reconnecting actions might be repeated endlessly at every node. Such a situation needs to be avoided. The fourth embodiment offers a solution for the situation.

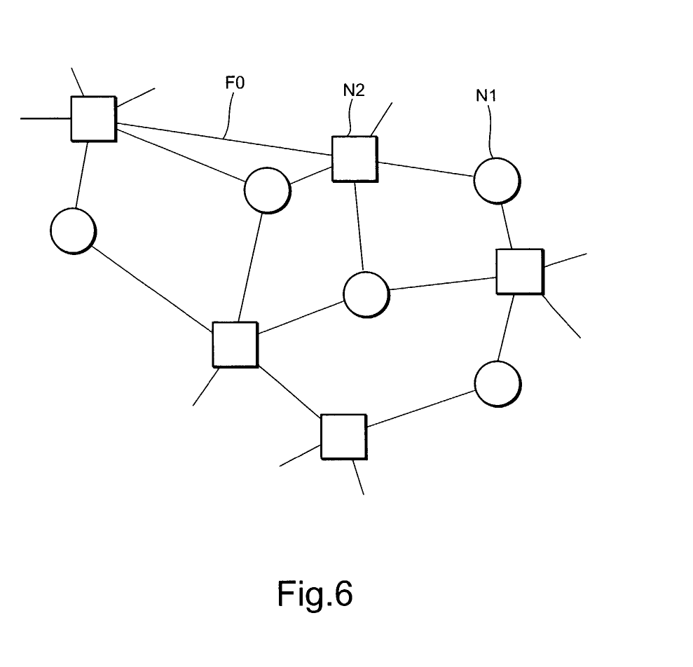

FIG. 6 is a block diagram of the fourth embodiment. The drawing illustrates an example of inter-node connection. In the drawing, circled blocks are rearrangeable and path non-blocking cross-connect nodes N1, squared blocks are strict-sense non-blocking cross-connect nodes N2, and lines connecting those blocks are transmission lines F0.

Specifically, a pair of rearrangeable and path non-blocking cross-connect nodes N1 are not directly connected to each other by the transmission line F0, but those nodes are always connected to each other via a strict-sense non-blocking cross-connect node N2. In this way, adverse effects on all the nodes of the network, which are caused by rearrangement, can be avoided by arranging the rearrangeable and path non-blocking cross-connect nodes N1 discontinuously on the network.

As described above, the following advantage can be obtained according to a cross-connect switch of the present invention. Specifically, in the cross-connect switch of the present invention, each of a plurality of outgoing lines is connected to a predetermined one of a plurality of paths. Meanwhile, an input signal does not designate an individual outgoing line. As a result, it is possible to reduce the number of unit switches as compared with the prior art.

While this invention has been described in connection with certain preferred embodiments, it is to be understood that the subject matter encompassed by way of this invention is not to be limited to those specific embodiments. On the contrary, it is intended for the subject matter of the invention to include all alternative, modification and equivalents as can be included within the spirit and scope of the following claims.

What is claimed is:

1. A cross-connect switch for transmitting an input signal to any one of a plurality of outgoing lines,
wherein the cross-connect switch comprises a switch, in which each output port thereof is connected to any one of the plurality of outgoing lines, and
each of the plurality of outgoing lines is connected to a predetermined one of a plurality of paths.

2. The cross-connect switch according to claim 1,
wherein the input signal is a wavelength division multiplexing optical signal, and
the cross-connect switch further comprises a demultiplexer for demultiplexing the input signal into wavelength components.

3. The cross-connect switch according to claim 2,
further comprising a multiplexer for multiplexing signals on the outgoing lines which are connected to any one of the plurality of paths.

4. The cross-connect switch according to claim 1,
wherein the switch includes a two-stage-linked connection circuit network.

5. The cross-connect switch according to claim 3, further comprising:
a first wavelength converter inserted between the demultiplexer and an input port of the switch; and
a second wavelength converter inserted between the output port of the switch and the multiplexer.

6. The cross-connect switch according to claim 3,
wherein a conversion wavelength of the second wavelength converter is variable.

7. The cross-connect switch according to claim 1, wherein the switch is rearrangeably non-blocking.

8. A network provided with a plurality of interconnected nodes, wherein the node includes the cross-connect switch according to claim 1.

9. The network according to claim 8,
wherein at least one of first cross-connect switches among the cross-connect switches includes the switch which is rearrangeably non-blocking, and
the first cross-connect switches are connected only to the cross-connect switches other than the first cross-connect switches.
